(19) United States
(12) Patent Application Publication
(10) Pub. No.: US 2014/0151279 A1
(43) Pub. Date: Jun. 5, 2014

(54) SYSTEM AND METHOD FOR FILM-BASED CHROMATOGRAPHIC SEPARATION

(71) Applicant: RENEWABLE PROCESS TECHNOLOGIES, LLC, Devens, MA (US)

(72) Inventor: James Banks, Mansfield, MA (US)

(73) Assignee: RENEWABLE PROCESS TECHNOLOGIES, LLC, Devens, MA (US)

(21) Appl. No.: 13/691,992

(22) Filed: Dec. 3, 2012

(51) Int. Cl. B01D 15/10

(52) U.S. Cl. CPC B01D 15/10
USPC 210/198.3; 210/198.2

(57) ABSTRACT

A film based chromatography system for capturing and releasing a material from a fluid. In one embodiment, the system includes a housing containing a spiral wound film element. The film element includes a material-capturing web and a fluid passageway web. In another embodiment, the system includes a series of such housings containing film element(s). In a further embodiment, the system includes a plurality of housings arranged in parallel and in series in various combinations. Controllers and valves are arranged to allow flexible fluid processing. The spiral wound film maximizes material contact area in the limited space and volume of the housing.

### BACKGROUND OF THE INVENTION

1. Field of the Invention

The present invention relates to systems and methods for removing materials from fluids. More particularly, the present invention relates to systems and methods for separating materials using thin films and chromatographic techniques. The present invention is a system and method for batch and continuous operations using chromographic thin films configured in spiral wound elements.

2. Description of the Prior Art

Processes to make biological products involve the use of bioreactors to culture cells in the course of making commercially important biomaterials through fermentation. Bioreactors can be employed in varying scales, up to and including at an industrial level and the type employed depends on the biomaterials used, the bioproducts to be made and process limitations. Biochemical technologies use enzymes or microorganisms to convert feedstock to the desired products, e.g., fermentation products. In some processes, such as those practiced in a separator bioreactor, removal of the product from the reaction vessel during the production process will increase the product yield, in some applications yield can be increased further by reducing the concentration of spent process components that can inhibit production by the fermentation organism. It is also desirable to remove by-products and contaminants to improve the efficiency and yield of the reaction. It may also be desirable to remove a product from a reaction vessel in its pure form, thus eliminating further conversion of the product into some other form, such as the formation of the salt of an organic acid. The conversion process normally generates waste streams that have to be disposed of in an environmentally sensitive and economically viable manner.

Some existing methods for separating fluids from one another involve either resin beads or the use of continuous web structures. The web structure can be packed with sorbent particles, coated with sorbent materials or sorbent fibers, or contain surface modified substrate. Generally, web based methods follow similar procedures wherein the web is passed through a solution containing the target biomaterials, contaminants and any other sort of desired products and undesirable byproducts. The web structure with material or materials attached to the sorbent material is then directed to a de-sorption tank where the material or materials are removed from the web structure. However, the sorption materials used with such web structures must interact chemically with the materials to be removed so it is difficult to remove them completely from the tank in a sufficiently effective manner.

The problem with respect to separation using chromatography resin beads or gels is that they require precise bed packing methods and high levels of particle filtration. For web based chromatography, inherent problems are with containment and cleanliness of the open bath design as well as limitations with carryover and concentration effects within the feed baths. The method and system described herein address the limitations of processing solutions contained in an isolating environment, processing solutions in a manner such that concentration effects of the targeted component in the process solution are minimized, and the method permits processing with an appreciable quantity of suspended solids in the solutions.

Efforts continue to develop improved and more efficient separation processes and materials for the removal of target materials from fluids such as in water remediation processes, the removal of contaminants from soil and for the recovery of target materials in the preparation of bioproducts and other products. One promising method and system involving film based chromatography is described in U.S. Pat. No. 7,285,219, which is incorporated herein by reference. The invention disclosed in that patent is a chromatographic web film separation method carried out with fluids such as water or fluids in bioreactors or other chemical processes to separate one or more desired components from fluids such as fermentation broths or other biomass mixtures. Generally, a fluid containing one or more target materials is brought into contact with a chromatographic separation film, which is coated on one or both sides with direct capture or other chromatographically active functional material, to remove the desired target material(s) from the fluid. The fluid can be brought into contact with the chromatographic separation film by various methods including passing the film through the fluid or applying the fluid to the film such as by spraying or other fluid coating techniques, e.g., slot head coating techniques.

The system of U.S. Pat. No. 7,285,219 provides a series of baths through which the web film structure passes in a continuous process. The film first enters a first bath type containing one or more materials to be removed from a fluid and captures the one or more materials thereon. Next, the film passes into a second bath type including a fluid selected to enable the removal (or release) of the captured one or more materials. Finally, the film passes into a third bath type including a fluid selected to re-equilibrate the web structure. Each bath type may comprise one or more baths.

The system of U.S. Pat. No. 7,285,219 has several limitations that can be improved. First, the continuous nature of any process associated with that system causes some difficulty concerning maintenance and changes to materials, components, equipment, and the like. For example in large scale industrial applications, the chromatographic web must be both chemically active and resilient as well as mechanically robust. That is, the entire process must be halted to make any changes to physical components of the system therefore equipment downtime for repair and maintenance will be costly. Second, the continuous web nature of the system, in which a single-layered film passes into all baths of the system, makes it difficult to scale up any developed process. For example, if the film surface area required to produce a certain output is on the order of 400 square feet and five baths are used to accommodate that film surface area, then an effort to scale up the output by an order of magnitude would require 4000 square feet of film and a proportional increase of bath volume, or some other arrangement that increases the bath volume substantially, to accommodate that film. The footprint of such a system is generally not desirable and, in any case, the maintenance of more/larger baths increases cost and complexity significantly. Third, the arrangement of the indicated system is more likely to expose the film to contaminants that may render the process inefficient, at best, or completely non-productive at worst. This is of particular importance for those chromatographic and other processes where microbial contamination must be substantially minimized, if not eliminated. Lastly, if the web based chromatography application calls for the complete removal of a component from a feed bath then concentration effects will render the chromatography operation less efficient.

What is needed is a film-based chromatography system and related method that are flexible in terms of maintenance opportunities and process change efforts. What is also needed is a film-based chromatography system and related method that are scalable in a cost-efficient way. Further, what is needed is a film-base chromatography system and related method that can handle moderate particle loading and be configured to minimize contamination circumstances.

### SUMMARY OF THE INVENTION

It is an object of the present invention to provide a film-based chromatography system and related method that are flexible in terms of maintenance opportunities and process change efforts. It is also an object of the present invention to provide a film-based chromatography system and related method that are scalable in a cost-efficient way, namely that concentration effects of the targeted components in the process solution is minimized. It is another object of the present invention to provide a film-base chromatography system and related method that are configured to minimize contamination circumstances. These and other objects are achieved with the present invention, which is a film-based chromatography separation system that includes a spiral wound film as the chromatography element rather than a single-layer film. The system includes one or more housings for containing the spiral wound film and enabling its contact with one or more fluids of interest in a particular separation process which includes capture, release/regeneration and re-equilibrium steps.

One or more housings of the system are configured to removably retain therein at least one spiral wound film. As a result, a fluid containing a target component in solution is directed to the housing, which contains one or more spiral elements. Fluid exiting the housing is depleted of the target component as the target component is captured upon the film of one or more spiral elements. A second fluid selected to release the target component (material) from the film. The second fluid is directed into one or more housings and when the second fluid exits the housing(s) it will also carry the target component that has been released from the film. In a similar manner, a third fluid may be directed to the housing in the bath for the purpose of re-equilibrating the film. In this configuration of the system of the present invention, the housing and film are used in batch mode. In this batch mode, fluid changes are accomplished with valve and control arrangements that regulate fluid feeds to and from the housing. This is a change from the prior system, which requires the use of multiple baths for separate capture, release and re-equilibration steps of a chromatographic separation process. The invention includes a system for separating a material from a fluid, the system comprising a housing including an inlet conduit for delivering the fluid into the housing(s) and an outlet conduit for transferring the fluid out of the housing; and a spiral wound film element removably retainable in the housing, wherein the film is selected to capture the material thereto. In an embodiment, the film element includes a first web that removably retains the material thereto and a second web that does not retain the material but establishes a passageway for the fluid to evenly pass across the film surface as the fluid passes through the element. The film element may be formed of multiple webs of similar performance as the first web described above as well as multiple second webs as described above, wherein each film element is retained by two porous end plates at the element inlet and outlet. The porous end plates permit the even distribution of liquid flow through while preventing telescoping of the spiral wound film media due to mechanical forces induced by hydraulic flow along the element's axis. The spiral film element may also include a non-permeable center tube that allows the ends of the web to be attached. The spiral wound element may also be configured as a wrap with a permeable, semi-permeable, or non-permeable material that encapsulates multiple webs, end caps, and center tube to ensure mechanical integrity of the film element.

The system of the present invention may also be used in a continuous mode. That may be accomplished using a plurality of housing sets, wherein each set may include one or more housing. While it is contemplated that there will be at least one film element in each housing, there may be instances where there are no film elements within a housing associated with a process. Additionally, there may be a plurality of film elements within one or more housings. When there are multiple film elements within a housing, those film elements are arranged in series with one another. Housings may be configured fluidly in both series and parallel configurations. It is to be understood that when a housing set includes a plurality of housings, those multiple housings may be arranged in fluid connection in series or in parallel with one another. A set housing set may include a combination of housings in fluid connection in series and in parallel. Housing sets themselves may be in fluid connection in series, in parallel or in a combination of both.

In one arrangement, a single housing set may perform functions of target component release and re-equilibration while one or more other housings remain on line for use in the capture function. In an alternative arrangement, a single housing set may perform all functions of capture, release and re-equilibration while one or more other housings sets are offline, such as for maintenance, or they may be used for capture, release and re-equilibration associated with a different targeted component. This arrangement allows for continuous fluid processing as a common fluid inlet and a common fluid outlet may be coupled to a housing set that is active and then coupled or switched to another housing set while the first is either not used or used for a different targeted component. It is also noted that the plurality of housing sets and housings within sets provides the functionality of expanding the film surface area available to scale up a fluid treatment process if desired.

The film based chromatography system of the present invention involves the use of elements of spiral wound chromatography film. Other surface area increasing element configurations utilizing the film may be employed in a housing. A housing may include a plurality of films of similar or different configuration. The system also includes housing arrangements that provide the user with flexibility to adjust process characteristics, including increasing fluid treatment capacity and ease of maintenance and other process modifications without impeding process continuity. These features provide for effective process scale-up without the need to greatly expand the number of components required and without the need to greatly expand the size of the process area. The invention may be used as an effective way to remove materials from fluids. In one example, but not limited to that example, the system can be used to remove toxins from fermentation media during the fermentation operation. These and other advantages provided by the present invention will become more apparent upon review of the following detailed description, accompanying drawings and appended claims.

### BRIEF DESCRIPTION OF THE DRAWINGS

FIG. 1 is a simplified schematic side view of a first embodiment of the system of the present invention comprising a housing with a spiral wound film.

FIG. 2 is a perspective view of the spiral wound film of the present invention.

FIG. 3 is a simplified schematic side view of a second embodiment of the system of the present invention showing a first housing set and a second housing set in series, wherein each housing set includes a single housing containing the spiral wound film.

FIG. 4 is a simplified schematic side view of a third embodiment of the system of the present invention showing a first housing set and a second housing set in series, wherein each housing set includes a plurality of individual housing in parallel, each housing containing the spiral wound film element.

FIG. 5 is a simplified flow diagram showing primary steps of an example method of the invention for treating a fluid in a film based chromatography process wherein the fluid includes a target component A and a target component B.

FIG. 6 is a simplified schematic side view of an embodiment of the housing with multiple film elements and a first film element sealing arrangement.

FIG. 7 is a simplified schematic side view of an embodiment of the housing with multiple film elements and a second film element sealing arrangement.

### DETAILED DESCRIPTION OF SEVERAL EMBODIMENTS OF THE INVENTION

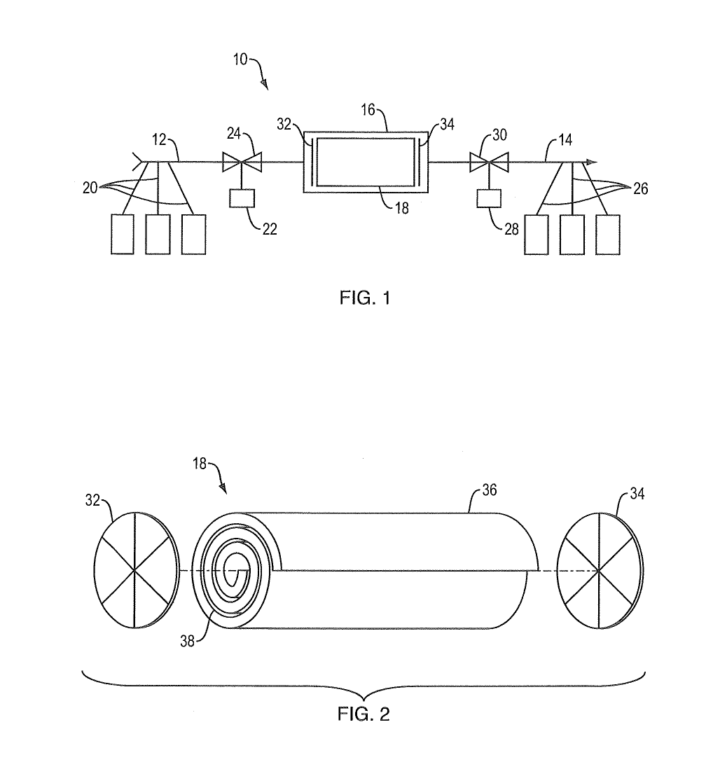

A first system 10 of the present invention suitable for treating a fluid in a chromatographic process is shown in FIG. 1. The system 10 includes an inlet conduit 12, an outlet conduit 14, a housing 16 and a spiral wound film element 18. The system 10 may include more than one such film element 18 in the housing 16. The inlet conduit 12 is fabricated of any material suitable to transport fluids of interest to the housing 16. One or more fluid delivery conduits 20 may be connected to the inlet conduit 12. Fluid flow into the inlet conduit 12 may be controlled by controller 22 and valve 24 that are coupled to the controller 22. A user may program the controller 22 to actuate the valve 24 to direct fluids from the delivery conduits 20 to the inlet conduit 12 as a function of the particular processing of the fluids and/or the spiral wound film element 18 in the housing 16.

Similarly, the outlet conduit 14 is fabricated of any material suitable to transport fluids of interest from the housing 16. One or more fluid output conduits 26 may be connected to the outlet conduit 14. Fluid flow from the outlet conduit 14 may be controlled by controller 28 and valve 30 that are coupled to the controller 28. A user may program the controller 28 to actuate the valve 30 to direct fluids from the outlet conduit 14 to the output conduits 26 as a function of the particular processing of the fluids and/or the spiral wound film element 18 in the housing 16. Controllers 22 and 28 may be operable in a coordinated manner as a function of the particular fluid processing. Valves 24 and 28 may each represent one or more valves, wherein the flow of fluids in conduits 20 and 26 may be regulated by individual valves.

The housing 16 may be fabricated of any material suitable for containing fluids to be processed at expected processing temperatures and pressures. The housing 16 is further selected and configured to retain therein the film elements 18. As an example, the housing 16 may be fabricated of stainless steel. Other suitable materials such as fiberglass may also be used. The housing 16 is typically tubular in nature with appropriate end connections that seal and secure the tube ends and is configured to support one or more film elements 18 per housing 16 of the present invention.

Each film element 18 contains two end plates, element inlet end plate 32 and element outlet end plate 34. These end plates 32/34 are used to prevent telescoping of the spiral wound film elements 18 due to mechanical forces induced by hydraulic flow along the axes of the film elements 18. That is, the plates 32 and 34 prevent the film element 18 from expanding at the center thereof in either or both directions when the fluid is directed thereto. The plates 32 and 34 are sufficiently porous to enable even distribution of fluid passing through each element yet of sufficient strength to minimize telescoping of the film elements 18. The plates 32 and 34 shall be designed to facilitate even distribution of fluid as two or more elements 16 are installed within a common housing 16. The plates 32 and 34 may be fabricated of polysulfone or other suitable thermoplastic material.

As illustrated in FIG. 2, the spiral wound film element 18 includes a first web 36 of active material and a second web 38 of inactive material. The first web 36 is a web of material that captures material contained in the fluid received from the inlet conduit 12. The first web 36 material is fabricated from Mylar®, or another suitable material capable of being surface modified to permit active site specific chemistry on one or both sides of the material. The second web 38 is selected of a material that does not capture material contained in the fluid but instead that establishes a passageway between layers of the first web 36 when the first web 36 and the second web 38 are layered together and wound into a spiral to establish the film element 18. The second web 38 material available is polypropylene, or some other thermoplastic such as polyethylene, or polyester.

As can be seen in FIG. 2, the film element 18, which is formed by rolling up the first web 36 layered to the second web 38, with the element shaped as a cylinder comprising alternating layers of the first web 36 and the second web 38. Fluid passage tangentially across the film 36 surface configured as an element 18 and installed in the housing 16 is facilitated by the second web 38 so that the fluid contacts front and back surfaces of each spiral of the first web 36. The first web 36 and the second web 38 are wrapped and are typically fitted with an inert exterior wrap to secure the element geometry and plates 32 and 34. Dwell time of the fluid on the first web 36 may be regulated by fluid flow rate into and through the housing 16. This configuration of the film element 18 as a spiral winding of the active material of the first web 36 provides much greater surface area within the housing 16 for contacting the fluid than is available in the prior art of a continuous web of a single layer in a bath of comparable hold up volume. The chemistry of the film element(s) of the first housing 106 may be the same as or different from the chemistry of the film element 18 of second housing 108 as a function of the particular solution processing desired, the extent of particle content of the solution or any other processing impact of interest.

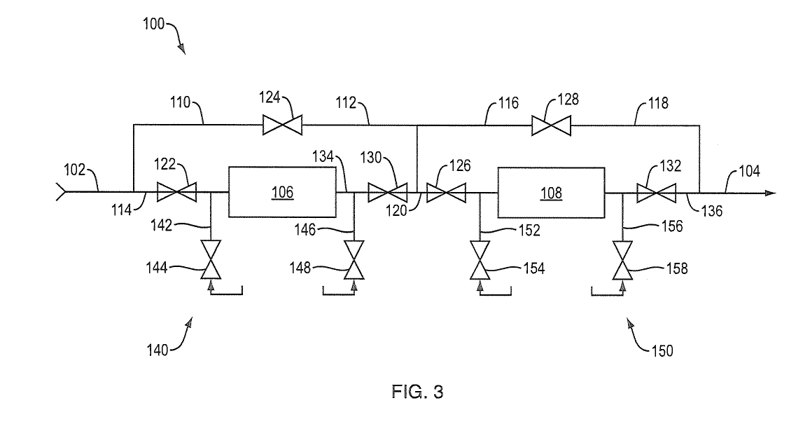

A second system 100 of the present invention suitable for treating a fluid in a chromatographic process is shown in FIG. 3, which represents a separation arrangement involving the use of a plurality of housings. While shown as a series of two housing sets, it is to be understood that the present invention may be embodied in the combination of a plurality of housing sets arranged in series. The system 100 includes a primary inlet conduit 102, a primary outlet conduit 104, a first housing set 106 and a second housing set 108. Each of the first housing set 106 and the second housing set 108 of the system 100 may be comprised of a single or multiple housings with each housing removably contains therein the spiral wound film elements 18.

The system 100 further includes bypass components so that either or both of the first housing 106 and the second housing 108 may be bypassed wherein a fluid in the primary inlet conduit 102 may be directed to the first housing 106 only, the second housing 108 only, or directed to flow through the first housing 106 followed by the second housing 108, to the primary outlet conduit 104. The bypass components for the first housing 106 include a first bypass conduit 110, flow control valve 124, and outlet bypass conduit 112. The first housing 106 is also equipped with inlet conduit 114 with inlet flow isolation valve 122, and buffer supply conduit 142 with inlet flow control valve 144. The first housing 106 is further equipped with outlet conduit 134 with outlet flow isolation valve 130, and buffer return conduit 116 with outlet flow control valve 148. The second housing 108 is also equipped with inlet conduit 120 with inlet flow isolation valve 126, and buffer supply conduit 152 with inlet flow control valve 154. The second housing 108 is further equipped with outlet conduit 136 with outlet flow isolation valve 132, and buffer return conduit 156 with outlet flow control valve 158. The movement of fluid into and out of the first housing 106 and the second housing 108 is regulated by one or more controllers and a plurality of valves

Inlet flow control valve 122 and outlet flow control valve 130 can close and serve to isolate first housing 106 from primary inlet conduit 102 while flow control valve 124 can operate open to effectively by-pass the first housing 106 and connect the primary inlet conduit 102 to the second housing 108. In a similar manner, inlet flow control valve 126 and outlet flow control valve 132 can close and serve to isolate second housing 108 from primary second housing inlet conduit 120 while flow control valve 128 can operate open to effectively by-pass the second housing 108 and connect the primary outlet conduit 104 to the first housing 106 outlet 120.

When valves 122 and 130 are open and valve 124 is closed, fluid moves from the primary inlet conduit 102 into first housing inlet conduit 114 wherein it contacts the film element(s) 18 located therein. In that instance, if the fluid is to pass from first housing outlet conduit 134 to the second housing 108, valves 126 and 132 are open, valve 128 is closed and the fluid moves from the first housing outlet conduit 134 to second housing inlet conduit 120. Valve 132, when open, permits movement of the fluid from second housing outlet conduit 136 to the primary outlet conduit 104. On the other hand, if the fluid is to pass from the first housing outlet conduit 134 to the primary outlet conduit 104 directly, valves 128 and 130 are open, valves 126 and 132 are closed and the fluid moves from the first housing outlet conduit 134 through bypass conduits 116 and 118 to the primary outlet conduit 104.

In an alternative use of the system 100 of FIG. 3, the first housing 106 may be bypassed and only the second housing 108 used to process the fluid from primary inlet conduit 102. In order to accomplish that, valve 122 is closed and valve 124 is opened so that fluid moves from the primary inlet conduit 102 into conduit 110. Valves 128 and 130 are closed and valves 126 and 132 are open so that the fluid moves from conduit 110 through conduit 112 into conduit 120 where it enters the second housing 108 for processing by contact with the film 18. The processed fluid then passes through conduit 136 to the primary outlet conduit 104.

The system 100 includes components to enable capabilities so that either a single or multiple housings within each of the first housing set 106 and/or the second housing set 108 may be taken off line for release and re-equilibrium operations while fluid in the primary inlet conduit 102 may be directed to the remaining on line housing(s) of the first housing set 106. The system 100 is configured so that the processing of fluid entering at primary inlet conduit 102 may be continuous in regard to removing material from the fluid using the film 18 while also allowing for release of captured material and re-equilibration of the film 18. The multiple housing in parallel for each housing set or the bypass features permit that processing flexibility. Typically, housings 106 and 108 operate in series and function together either simultaneously or in an alternating mode performing the capture step. Once one of the housings 106/108 approaches its capacity to capture the target component, the housing of housings 106/108 that is at or near capacity is isolated to enable operational steps of release/regeneration and re-equilibrium to occur therein while in isolation from the capture step carried out by the other of housings 106/108. A control device may be employed to monitor and control the anticipated throughput of the capture step at each respective housing. For example, when it has been determined that the material capture capacity of the film element 18 in the first housing 106 has been reached, the first housing 106 may be taken offline by bypassing it through the valve control arrangement described above. At the same time, the second housing 108 may remain operational to capture material from the fluid. As that continuous treatment occurs in second housing 108, the film element 18 in the first housing 106 is treated for material release and capture. Specifically, first housing regeneration subsystem 140 is brought online to deliver film treatment and restorative fluids into the first housing 106.

The first housing regeneration system 140 includes an inlet conduit 142, inlet valve 144, an outlet conduit 146 and outlet valve 148. In order to regenerate the film 18 in the first housing 106, valves 122 and 130 are closed and valves 144 and 148 are opened. Fluid containing either or both of material release and film re-equilibration components from one or more sources fluidly connected to the inlet conduit 142 are delivered into the first housing 106 and are allowed to pass tangentially across the film 18 and through the element in the housing 106 before exiting the conduits 134 and 146. Alternatively, the regeneration fluids may be delivered to the housing 106 with valve 148 closed and the fluid allowed to dwell in the housing 106 for a selectable period of time. Valve 148 may then be opened to allow transfer of the spent fluid from the housing 106 into conduit 146 for delivery to a recovery tank (not shown).

When it has been determined that the material capture capacity of the film element 18 in the second housing 108 has been reached in a continuous fluid treatment process, the second housing 108 may be taken offline by bypassing it through the valve control arrangement described above. At the same time, the first housing 106 may remain operational, or brought online if it had been bypassed, to capture material from the fluid. As that continuous treatment occurs in first housing 106, the film element 18 in the second housing 108 is treated for material release and capture. Specifically, second housing regeneration subsystem 150 is brought online to deliver film treatment and restorative fluids into the second housing 108.

The second housing regeneration system 150 includes an inlet conduit 152, inlet valve 154, an outlet conduit 156 and outlet valve 158. In order to regenerate the film 18 in the second housing 108, valves 126 and 132 are closed and valves 154 and 158 are opened. Fluid containing either or both of material release and film re-equilibration components from one or more sources fluidly connected to the inlet conduit 152 are delivered into the second housing 108 and are allowed to pass directly through tangentially across the film 18 and through the element in the housing 108 before exiting the conduits 136 and 156. Alternatively, the regeneration fluids may be delivered to the housing 108 with valve 158 closed and the fluid allowed to dwell in the housing 108 for a selectable period of time. Valve 158 may then be opened to allow transfer of the spent fluid from the housing 108 into conduit 156 for delivery to a recovery tank (not shown).

The system 100 includes one or more controllers selected and configured to regulate the operation of the valves and the input sources to the primary inlet conduit 102 and to the first housing regeneration system 140 and the second housing regeneration system 150. These controllers may be one or more Allen-Bradley CompactLogix programmable logic controllers. When a plurality of controllers is used, they may be operated in a coordinated fashion to facilitate the process of fluid treatment. The conduits and the housings of the system 100 are fabricated of material sufficient to retain and transfer the fluids moved therein under expected operating conditions, including temperature and pressure. The system 100 may include heater(s) and flow controls to regulate temperature and contact time therein in housings 106 and 108. Each of the elements 18 associated with the housings 106 and 108 include a set of end plates, such as plates 32 and 34 described in regard to the system of FIG. 1 and FIG. 2, for the films retained in the two respective housings 106/108. Each of the inlet conduits of the system 100 may be coupled to one or more fluid sources for supplying fluid to be treated, fluid for removing material from the film element 18 and fluid for regenerating the film element 18. Each of the outlet conduits of the system 100 may be coupled to one or more fluid receiving tanks to retain or separately treat fluid exiting either or both of the housings 106 and 108. Each of the housings 106 and 108 includes at least one access port for a configuration for gaining access to the film element 18 therein and to generally conduct maintenance with the housings 106 and 108. The system 100 also includes one or more sensors for sensing conditions within the housings 106 and 108, as well as in one or more of the conduits described. The one or more sensors may be coupled to the one or controllers to provide information that may impact one or more of the valves, heaters and fans.

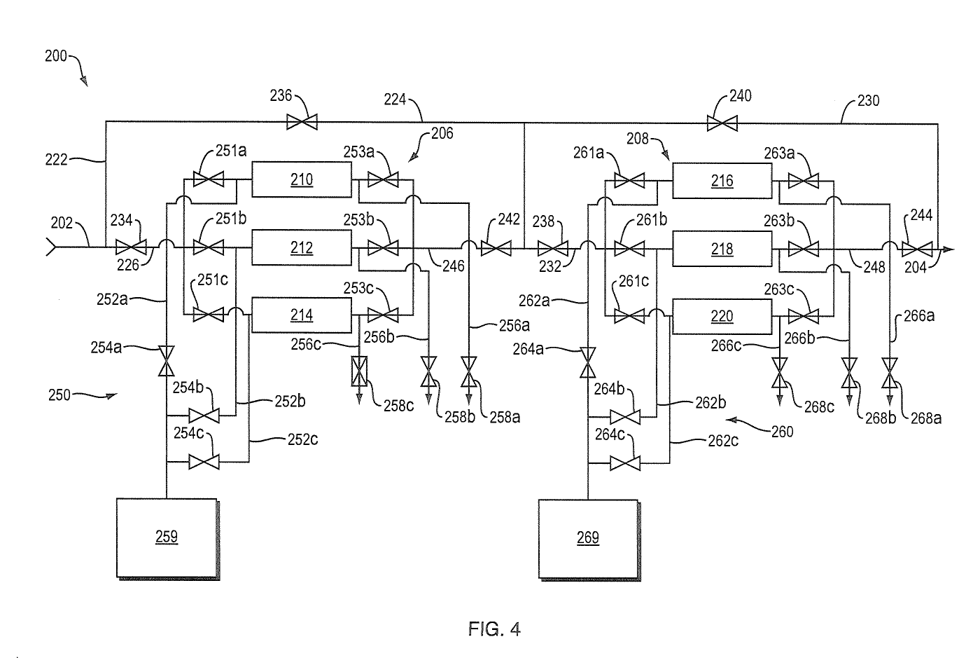

A third system 200 of the present invention suitable for treating a fluid in a chromatographic process is shown in FIG. 4, which represents a separation arrangement involving the use of a plurality of sets of housings in parallel. While shown as two sets of three housings, it is to be understood that the present invention may be embodied in the combination of a plurality of housings arranged in parallel and a plurality of such sets in series. Other configurations may have more or fewer housings per parallel set and there may be more sets in series. The system 200 includes a primary inlet conduit 202, a primary outlet conduit 204, a first housing set 206 and a second housing set 208. The first housing set 206 includes a plurality of housings represented as three housings, housings 210, 212 and 214. It is to be understood that the first housing set 206 may comprise more or fewer housings. The second housing set 208 includes a plurality of housings represented as three housings, housings 216, 218 and 220. It is to be understood that the second housing set 208 may comprise more or fewer housings. Each of housings 210-220 of the system 200 removably contains therein the spiral wound film element 18. However, in some instances, a user may have the spiral wound film elements 18 comprised of differing film 36 with differing film chemistries in housings as a function of the process required for treating a fluid of interest. Nevertheless, it is contemplated that at least one of the housings 210-220 includes the film element 18.

The system 200 further includes bypass components so that either or both of the first housing set 206 and the second housing set 208 may be bypassed wherein a fluid in the primary inlet conduit 202 may be directed to the first housing set 206 only, the second housing set 208 only or through both to the primary outlet conduit 204. The bypass components for the first housing set 206 include a first housing set bypass conduit 222, a first housing set inlet isolation control valve 234, a first housing set bypass control valve 236, a first housing set conduit 224, a first housing set inlet conduit 226, a second housing set inlet conduit 228, a second housing set bypass outlet conduit 230, a second housing set inlet isolation control valve 238, a second housing set bypass control valve 240 and a second housing set inlet conduit 232. The first housing set 206 example shown includes parallel housings 210, 212, 214 each equipped with inlet/outlet conduit isolation arrangements, and buffer supply conduits 252a-252c with flow control valves 254a-254c. The first housing set 206 is further equipped with outlet conduit 246 with outlet flow isolation valve 243, and buffer return conduits 256a-256c with flow control valves 258a-258c. The second housing 208 is also equipped with second housing set inlet conduit 232 with inlet flow isolation valve 238, and buffer supply conduits 262a-262c with flow control valves 264a-264c. The second housing 208 further includes outlet conduit 248 with outlet flow isolation valve 244, and buffer return conduits 266a-266c with flow control valves 268a-268c. The movement of fluid into and out of the first housing set 206 and the second housing set 208 is regulated by one or more controllers and a plurality of valves as indicated. First housing set inlet flow control valve 234 and outlet flow control valve 242 can close and serve to isolate the first housing set 206 from primary inlet conduit 202 while bypass flow control valve 236 can operate open to effectively by-pass the first housing set 206 and connect the primary inlet conduit 202 to the second housing set 208. In a similar manner second housing set inlet flow control valve 238 and outlet flow control valve 244 can close and serve to isolate second housing set 208 from second housing set inlet conduit 228 while flow control valve 240 can operate open to effectively by-pass the second housing set 208 and connect the primary outlet conduit 204 to the first housing set 206 outlet.

When valve 234 is open and valve 236 is closed, fluid moves from the primary inlet conduit 202 into first housing set inlet conduit 226 for delivery to one or more of housings 210-214. In that instance, if the fluid is to pass from first housing set outlet conduit 246 to the second housing set 208, valves 242 and 238 are open, valve 240 is closed and the fluid moves from the first housing set outlet conduit 246 to second housing set inlet conduit 232. Valve 244, when open, permits movement of the fluid from second housing set outlet conduit 248 to the primary outlet conduit 204. On the other hand, if the fluid is to pass from the first housing set outlet conduit 246 to the primary outlet conduit 204 directly, valves 240 and 242 are open, valves 238 and 244 are closed and the fluid moves from the first housing set outlet conduit 246 through bypass conduits 228 and 230 to the primary outlet conduit 204. All valves associated with regeneration/regeneration are closed when all of housings 210-220 are online and processing fluid.

In an alternative use of the system 200 of FIG. 4, the first housing set 206 may be bypassed and only the second housing set 208 used to process the fluid from primary inlet conduit 202. In order to accomplish that, valve 234 is closed and valve 236 is opened so that fluid moves from the primary inlet conduit 202 into conduit 222. Valves 240 and 242 are closed and valves 238 and 244 are open so that the fluid moves from conduit 222 through conduit 224 into conduit 232 for delivery to one or more of housings 216-220. The processed fluid then passes through conduit 248 to the primary outlet conduit 204.

The system 200 is configured so that the processing of fluid entering at primary inlet conduit 202 may be continuous in regard to removing material from the fluid using the film element 18 while also allowing for release of captured material and re-equilibration of any film element 18 contained in any of housings 210-220. The bypass features permit that processing flexibility. Typically, housing sets 206 and 208 operate in series and function together either simultaneously or in an alternating mode performing the capture step. Once one of the housing sets, either completely or partially, approaches its capacity to capture the target component, the housing is isolated to enable operational steps of release/regeneration and re-equilibrium to occur while in isolation from the capture step. A control device may be employed to monitor and control the anticipated throughput of the capture step at each respective housing. For example, when it has been determined that the material capture capacity of the one or more film elements 18 in the first housing set 206 has been reached, the first housing set 206 may be taken offline by bypassing it through the valve control arrangement described herein. At the same time, the second housing set 208 may remain operational to capture material from the fluid. As that continuous treatment occurs in second housing set 208, the one or more films 18 in the first housing set 206 are treated for material release and re-equilibrium. Specifically, first housing set regeneration subsystem 259 is brought online to deliver film treatment and restorative fluids into the first housing set 206. In a similar manner, second housing set regeneration subsystem 269 is brought online to deliver film treatment and restorative fluids into the second housing set 208.

The first housing set regeneration system 259 includes a first inlet conduit 252a, a first inlet valve 254a, a first outlet conduit 256a and a first outlet valve 258a associated with the housing 210, a second inlet conduit 252b, a second inlet valve 254b, a second outlet conduit 256b and a second outlet valve 258b associated with the housing 212, and a third inlet conduit 252c, a third inlet valve 254c, a third outlet conduit 256c and a third outlet valve 258c associated with the housing 214. In order to regenerate the one or more films 18 in housing 210, valves 251a and 253a are closed and valves 254a and 258a are opened. In order to regenerate the one or more films 18 in housing 212, valves 251b and 253b are closed and valves 254b and 258b are opened. In order to regenerate the one or more films 18 in housing 214, valves 251c and 253c are closed and valves 254c and 258c are opened. It is to be noted that any combination of the housings 210-214 may be taken offline for generation while one or more of the others may remain online. It is further noted that all of the housings 210-214 of the first housing set 206 may be taken offline for regeneration of all associated film elements 18. Typically in this mode of operation valves 234 and 242 are closed and first housing set bypass valve 236 is opened to enable continuous treatment of the fluid using second housing set 208. Fluid containing either or both of material release and film re-equilibration components from one or more sources represented by tank 259 fluidly connected to the inlet conduits 252a-252c are delivered into the first housing set 206 and are allowed to pass directly through one or more of the housings 210-214 before exiting the conduits 256a-256c. Alternatively, the regeneration fluids may be delivered to one or more of the housings 210-214 with the corresponding ones of valves 258a-258c closed and the fluid allowed to dwell in one or more of housings 210-214 for a selectable period of time. Those of valves 258a-258c that were closed may then be opened to allow transfer of the spent fluid from the one or more housings of housings 210-214 into the associated ones of conduits 256a-256c for delivery to a recovery tank (not shown).

When it has been determined that the material capture capacity of the one or more films 18 in the second housing set 208 has been reached in a continuous fluid treatment process, the second housing set 208 may be taken offline by bypassing it through the valve control arrangement described above. At the same time, the first housing set 206 may remain operational, or brought online if it had been bypassed, to capture material from the fluid. As that continuous treatment occurs in first housing set 206, the one or more films 18 in the second housing set 208 are treated for material release and capture. Specifically, second housing set regeneration subsystem 260 is brought online to deliver film treatment and restorative fluids into the second housing set 208.

The second housing regeneration system 260 includes a first inlet conduit 262a, a first inlet valve 264a, a first outlet conduit 266a and a first outlet valve 268a associated with the housing 216, a second inlet conduit 262b, a second inlet valve 264b, a second outlet conduit 266b and a second outlet valve 268b associated with the housing 218, and a third inlet conduit 262c, a third inlet valve 264c, a third outlet conduit 266c and a third outlet valve 268c associated with the housing 220. In order to regenerate the one or more films 18 in housing 216, valves 261a and 263a are closed and valves 264a and 268a are opened. In order to regenerate the one or more films 18 in housing 218, valves 261b and 263b are closed and valves 264b and 268b are opened. In order to regenerate the one or more films 18 in housing 220, valves 261c and 263c are closed and valves 264c and 268c are opened. It is to be noted that any combination of the housings 216-220 may be taken offline for generation while one or more of the others may remain online. It is further noted that all of the housings 216-220 of the second housing set 208 may be taken offline for regeneration of all associated film elements 18. Fluid containing either or both of material release and film re-equilibration components from one or more sources represented by tank 269 fluidly connected to the inlet conduits 262a-262c are delivered into the second housing set 208 and are allowed to pass directly through one or more of the housings 216-220 before exiting the conduits 266a-266c. Alternatively, the regeneration fluids may be delivered to one or more of the housings 216-220 with the corresponding ones of valves 268a-268c closed and the fluid allowed to dwell in one or more of housings 216-220 for a selectable period of time. Those of valves 268a-268c that were closed may then be opened to allow transfer of the spent fluid from the one or more of housings 216-220 into the associated ones of conduits 266a-266c for delivery to a recovery tank (not shown).

The system 200 includes one or more controllers selected and configured to regulate the operation of the valves and the input sources to the primary inlet conduit 202 and to the first housing set regeneration system 250 and the second housing set regeneration system 260. These controllers may be one or more Allen-Bradley CompactLogix programmable logic controllers. When a plurality of controllers is used, they may be operated in a coordinated fashion to facilitate the process of fluid treatment. The conduits and the housings of the system 200 are fabricated of material sufficient to retain and transfer the fluids moved therein under expected operating conditions, including temperature and pressure. The regeneration systems 250 and 260 as well as housing sets 206 and 208 may include heaters and fans to regulate temperature, fluid flow, air flow, and pressure conditions of the housings thereof. Each of housings 210-220 may include a set of plates, such as plates 32 and 34 described in regard to the system of FIG. 1, for those housings including film 18 retained therein. Each of the inlet conduits of the system 200 may be coupled to one or more fluid sources for supplying fluid to be treated, fluid for removing material from the film 18 and fluid for regenerating the film 18. Each of the outlet conduits of the system 200 may be coupled to one or more fluid receiving tanks to retain or separately treat fluid exiting either or both of the housing sets 206 and 208. Each of the housings of housing sets 206 and 208 includes at least one access port for a configuration for gaining interior access for maintenance, including maintenance of any film therein. The system 200 also includes one or more sensors for sensing conditions within the housings 210-220, as well as in one or more of the conduits described. The one or more sensors may be coupled to the one or controllers to provide information that may impact one or more of the valves, heaters and fans.

Each of the housings 210-220 includes its own set of inlet and outlet valves controllable to allow use or bypass of each housing as part of a separation process as noted above with respect to the description of the operation of the regeneration systems 250 and 260. That is, not only does the system 200 allow for the use or bypass of either or both of housing sets 206 and 208, it is configured to enable the use or bypass of each housing within a set. For example, and not limited thereto, housing 210 of first housing set 206 and housing 216 of second housing set 208 may be used by opening their respective valves 251a/253a and 261a/263a while housings 212 and 214 of first housing set 206 and housings 218 and 220 of second housing set 208 may be bypassed by maintaining their valves 251b/253b, 251c/253c, 261b/263b and 261c/263c closed. In that configuration, material capture may be carried out in housings 210 and 220, while the remaining housings may undergo either or both of release and re-equilibration processing, or any other process activities that may be of interest. It can be seen that a broad range of processing flexibility exists with a system such as that of system 200, wherein continuous processing may occur while offline activities, such as maintenance, may occur without diminishing the primary processing steps. This flexibility is enabled by this arrangement of housings and conduits as well as controller and valve arrangements that ensure each housing may be selected for use when desired. It is also to be noted that individual housings within either or both of housings sets 206 and 208 may be operated individually. For example, but not limited thereto, within first housing set 206, housing 210 may be taken offline for regeneration while housings 212 and 214 continue to operate. Of course, other variations of operation and regeneration processing for all of the housings of first housing set 206 and second housing set 208 may be employed as desired. Further, it is noted that each housing of housing sets 206 and 208 may have the same or different film chemistry of the film elements 18, as well as any combinations of the same and different film chemistries as a function of the particular solution(s) processing desired, the extent of particle content of the solution(s) or any other processing impact of interest.

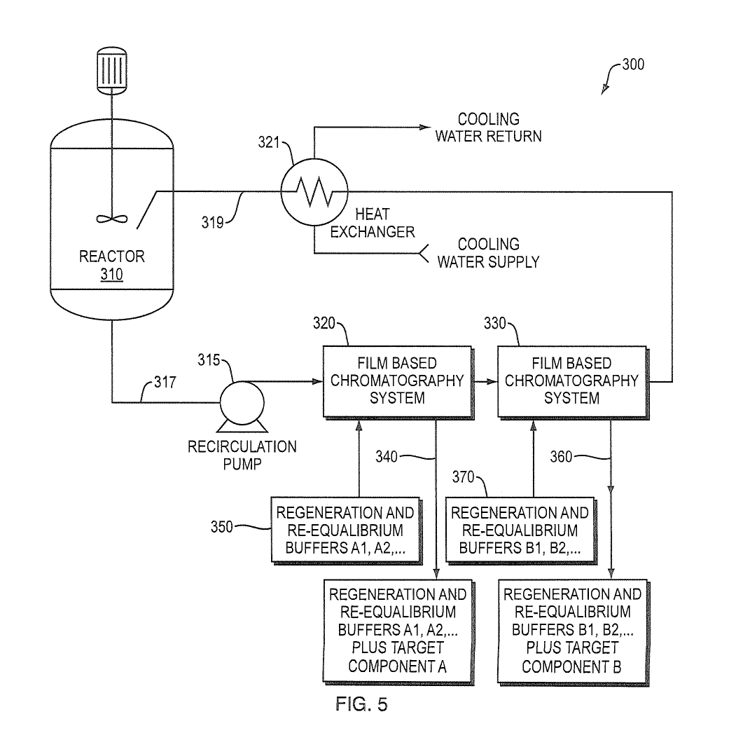

FIG. 5 is a simplified flow diagram showing primary steps of an example method 300 of the invention for treating a fluid from a reactor using a film based chromatography process. In this method 300, a conventional reactor (fermentor) 310 can be converted to a perfusion-style reactor without the limitations of mass transport across a semi-permeable membrane. The method 300 includes a first stage chromatography stage process 320 for removing a target component A from the fluid using one of the systems 100/200 described herein. The method 300 also includes a second stage chromatography stage process 330 for removing a target component B from the fluid using one of the systems 100/200 described herein. In this example, the target component A may be the desired fermentation product and the target component B may be a known growth inhibitor or biological toxin that needs to be removed from the fluid in order to achieve optimal performance of the reactor 310. Important attributes for this invention are that the film elements 18 can handle light to moderate particle loading and they can be contained in the housings as described and thereby isolate contents of the reactor 310 that circulate through the film elements 18 to limit or eliminate contamination of the reactor 310 for the desired fermentation process.

In the method 300, the fluid from the reactor 310 is directed, such as by using a controlled pump 315 through an untreated fluid conduit 317 that may pass through a heat exchanger 319 (located either before or after) the first stage process 320. In step 340, the fluid received from the reactor 310 is captured in the first stage process 320 for the purpose of removing desirable target component A and regenerating and re-equilibrating the elements 18 of the first stage process 320. In step 350, a first treatment buffer suitable for target component A is regenerated and re-equilibrated for delivery to the first stage process 320. In step 360, fluid with target component A removed is transferred to the second stage process 330 for the purpose of removing undesirable target component B and regenerating and re-equilibrating the elements 18 of the second stage process 330. In step 370, a treatment buffer suitable for target component B is regenerated and re-equilibrated for delivery to the second stage process 330. Treated fluid may then be returned to the reactor 310 through treated fluid conduit 319 and may be temperature controlled by passing it through heat exchanger 321, for example. In this way, the reactor 310 may be operated continuously if desired. It is to be understood that the method 300 of the present invention using the systems 100/200 as described may be varied to treat fluid such that target component A is the undesirable product and target component B is the desirable one. It may also be used to take one of processes 320 and 330 offline while the other remains online. Further, one or more housings within either or both of the processes 320/330 may be taken offline while others remain online, wherein regeneration and re-equilibration, as well as the addition or modification of desirable specific chemistry or chemistries to add to the fluid or for adjustments of the elements 18 may occur while housings or processes retained online continue to perform for the purpose of benefiting the reaction process associated with the reactor 310.

The steps of the method 300 may be automated using a controller such as one or more Allen-Bradley CompactLogix programmable logic controllers. Piping manifolds, valves, pumps and instruments are interfaced with the appropriate controls for taking one or more housings associated with the processing of the target component A offline, dependent on whether system 100, system 200 or a combination thereof is used, for regenerating and re-equilibrating the contents within the housing(s) while the other housing(s) remain online. The target Component A may be a primary product, a secondary product or another desired product.

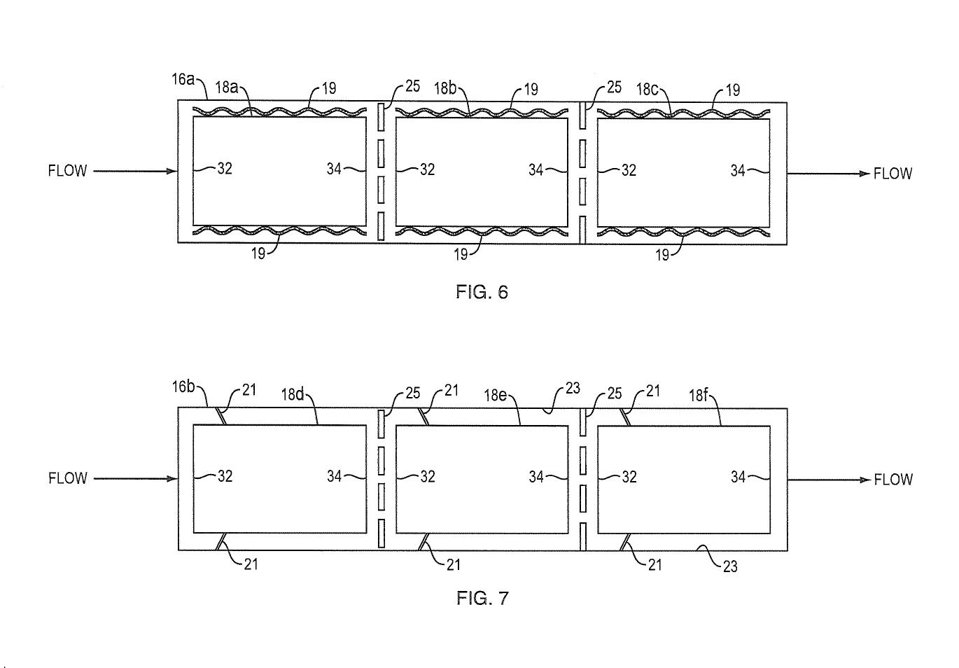

FIGS. 6 and 7 illustrate alternative embodiments of the invention wherein a plurality of film elements 18a-18f are contained within a single housing 10. The plural film elements 18 are arranged in series such that the fluid flowing into the housing 16a or the housing 16b encounters first film element 18a/18d, entering through its end plate 32 and exiting through end plate 34. It then moves to second film element 18b/18e before passing through third film element 18c/18f before exiting the housing 16a/16b. The end plates 32 and 34 are of the form, configuration and material as described with respect to the end plates of FIGS. 1 and 2. The film elements 18a-18c of FIG. 6 are retained within the housing 16a in a permeable/semi-permeable material 19 which aids in the mechanical integrity of the film element 18a-18c and substantially prevents fluid passing through the housing 16a from bypassing the active chromatographic film of the film elements 18a-19c. The permeable/semi-permeable material 19 may be formed of polyethylene or other suitable material sufficient to prevent the fluid to avoid contact with the chromatographic film. The film elements 18d-18f of FIG. 7 include an outer wrap and are retained within the housing 16b by a seal 21 located between the outer wrap of the film element 18d-18f and interior housing wall 23 that substantially prevents fluid passing through the housing 176b from bypassing the active chromatographic film of the film elements 18d-18f. The seal 21 may be formed of EPDM (ethylene propylene diene monomer) or other suitable material sufficient to prevent the fluid to avoid contact with the chromatographic film. With further reference to FIGS. 6 and 7, when a plurality of film elements 18 are contained in the housing 16, they may be separated from one another by spacers 25 to allow for the fluid passing from one element to the next to reconstitute and mix. This enhances processing of the fluid. These spacers 25 may be similar in configuration to the end plates 32 and 34 in that they are porous and permit fluid passage while enabling even distribution of fluid throughout the housing. The spacers 25 may be standoffs or spider components that allow for mixing between film elements 18. The spacers 25 may be formed of polysulfone or other suitable material.

The present invention has been described with respect to various examples. It is to be noted that one or more steps of the method 300 may be carried out in parallel or in a different order than described in the embodiment disclosed. Therefore, it is to be understood that various modifications may be made without departing from the spirit and scope of the invention. Accordingly, other embodiments are within the scope of the claims appended hereto.

What is claimed is:

1. A system for separating a material from a fluid, the system comprising:
a. a housing including an inlet conduit for delivering the fluid to the both and an outlet conduit for transferring the fluid out of the housing; and
b. a spiral wound film element removably retainable in the housing, wherein the film element is selected to capture the material thereto.

2. The system of claim 1, wherein the film element includes a first web that removably retains the material thereto and a second web that does not retain the material but establishes a passageway for the fluid to pass through the film element.

3. The system of claim 1, further comprising a first plate and a second plate, wherein the first plate and the second plate are arranged to retain the film element in the housing.

4. The system of claim 3, wherein the first plate and the second plate are porous and permit bulk flow of the fluid therethrough while preventing telescoping of the spiral wound film media due to mechanical forces induced by hydraulic flow along the film element's axis.

5. A system for separating a material from a fluid, the system comprising:
a. a first inlet conduit for transferring the fluid;
b. a first housing coupled to the first inlet conduit for receiving the fluid;
c. a first spiral wound film element retainable in the first housing;
d. a first outlet conduit coupled to the first housing;
e. a second inlet conduit coupled to the first outlet conduit for receiving the fluid from the first housing;
f. a second housing coupled to the second inlet conduit;
g. a second spiral wound film retainable in the second housing; and
h. a second outlet conduit for transferring the fluid out of the second housing.

6. The system of claim 5, wherein the each of the first film element and the second film element includes a first web that removably retains the material thereto and a second web that does not retain the material but establishes a passageway for the fluid to pass through the film.

7. The system of claim 5, further comprising for each film element a first plate and a second plate, wherein the first plate and the second plate are arranged to retain and maintain the spiral webs within the spiral film element.

8. The system of claim 7, wherein the first plate and the second plate are porous.

9. The system of claim 5, further comprising a first housing regeneration system fluidly connected to the first housing configured to release the material from the first film.

10. The system of claim 9, further comprising a second housing regeneration system fluidly connected to the second housing configured to release the material from the second film.

11. The system of claim 5, further comprising a first bypass fluidly connected to the first housing for diverting the fluid from the first inlet conduit directly to the second inlet conduit.

12. The system of claim 11, further comprising a second bypass fluidly connected to the second housing for diverting the fluid from the first outlet conduit directly to the second outlet conduit.

13. A system for separating a material from a fluid, the system comprising:
a. a first inlet conduit for transferring the fluid;
b. a first housing set coupled to the first inlet conduit for receiving the fluid, wherein the first housing set includes one or more housings;
c. a first spiral wound film retainable in one or more of the one or more housings;
d. a first outlet conduit coupled to the first housing set;
e. a second inlet conduit coupled to the first outlet conduit for receiving the fluid from the first housing set;
f. a second housing set coupled to the second inlet conduit, wherein the second housing set includes one or more housings;
g. a second spiral wound film retainable in one or more of the one or more housings of the second housing set; and
h. a second outlet conduit for transferring the fluid out of the second housing set.

14. The system of claim 13, wherein the each of the first film and the second film includes a first web that removably retains the material thereto and a second web that does not retain the material but establishes a passageway for the fluid to pass through the film.

15. The system of claim 13 further comprising for each housing including the film a first plate and a second plate, wherein the first plate and the second plate are arranged to retain the film in the housing.

16. The system of claim 15, wherein the first plate and the second plate are porous.

17. The system of claim 13, further comprising a first housing set regeneration system fluidly connected to the first housing set configured to release the material from the film of the one or more housings of the first housing set.

18. The system of claim 17, further comprising a second housing set regeneration system fluidly connected to the second housing set configured to release the material from the film of the one or more housings of the second housing set.

19. The system of claim 13, further comprising a first bypass fluidly connected to the first housing set for diverting the fluid from the first inlet conduit directly to the second inlet conduit.

20. The system of claim 19, further comprising a second bypass fluidly connected to the second housing set for diverting the fluid from the first outlet conduit directly to the second outlet conduit.

21. The system of claim 13, further comprising a set of parallel housings containing separation film elements of a common chemistry followed by a second set of parallel housings containing separation film elements with a common, but differing chemistry so as to effect the sequential removal of two or more target components form the feed solution.

22. The system of claim 13, further comprising a set of parallel housings containing separation film elements of a common chemistry followed by a second set of parallel housings containing separation film elements with a common, but differing chemistry so as to effect the sequential recovery of two target components, wherein one of the two target components is separated from the fluid in the first set of parallel housings and a second one of the two target components is separated from the fluid in the second set of parallel housings.

23. The system of claim 2, wherein the spiral film element includes a non-permeable center tube that allows the ends of the web to be attached.

24. The system of claim 1, wherein the film element is wrapped with a permeable, semi-permeable, or non-permeable material that encapsulates multiple webs, end caps, and center tube to ensure mechanical integrity of the film element.

25. The system of claim 2, wherein the film element includes multiple webs of similar performance as the first web and multiple webs of similar performance as the second web.

26. The system of claim 4, wherein the film element includes chromatographic film and fluid passage webs.

27. The system of claim 3, wherein the housing includes a plurality of film elements, the system comprising secondary plates between each of the plurality of film elements.

28. The system of claim 1, further comprising a seal located between the film element and an interior housing wall of the housing that substantially prevents fluid passing through the housing from bypassing the film element.

29. The system of claim 1, further comprising a permeable/semi-permeable material between the film element and an interior housing wall of the housing which aids in the mechanical integrity of the film element and substantially prevents fluid passing through the housing from bypassing the film element.
